(19) United States
(12) Patent Application Publication
(10) Pub. No.: US 2023/0124832 A1
(43) Pub. Date: Apr. 20, 2023

(54) Concept for Handling Transient Errors

(71) Applicants: William DIETER, Hillsboro, OR (US); Kermin CHOFLEMING, Hudson, ME (US); Cameron MCNAIRY, Windsor, CO (US)

(72) Inventors: William DIETER, Hillsboro, OR (US); Kermin CHOFLEMING, Hudson, ME (US); Cameron MCNAIRY, Windsor, CO (US)

(21) Appl. No.: 18/067,742

(22) Filed: Dec. 19, 2022

(51) Int. Cl. G06F 11/07; G06F 11/10; G06F 11/36

(52) U.S. Cl. CPC G06F 11/0703; G06F 11/106; G06F 11/36

(57) ABSTRACT

Examples relate to a concept for handling transient errors. An apparatus for correcting transient errors in a computational device comprises interface circuitry, machine-readable instructions and processing circuitry for executing the machine-readable instructions to obtain a signal indicating that a transient error has been detected in the computational device, the computational device being configured to perform computations using processing elements and connections between the processing elements, extract a state of the computational device, the state comprising at least one of present and previous values transmitted via the connections between the processing elements and state contained within the one or more processing elements, compute a corrected state of the computational device based on the state extracted from the computational device, and configure a computational device with the corrected state.

### BACKGROUND

Spatial fabric architectures, such as Field-Programmable Gate Arrays (FPGAs) and Coarse-Grained Reconfigurable Arrays (CGRAs), like the Intel® Configurable Spatial Accelerator (CSA), often represent computation as a graph, with processing elements performing the computations being modeled by the nodes of the graph and the data dependencies between the computations being modeled by the edges of the graph. During computation, mechanisms like parity or residue can detect errors caused by transient faults, but the errors are not inherently correctable.

The idea of replaying failed calculations with uncorrupted data exists in many microprocessors, in the context of speculative execution. There, error correction is accomplished by clearly separating the architectural or canonical state from the speculative state and discarding the speculative state when an error is detected in it. Such distinctions between a canonical state and speculative state are generally not made in the novel paradigm of graph execution on spatial architectures. In particular, such graphs do not contain speculative state. Thus, approaches regarding error recovery in the context of speculative execution do not apply to graphs as currently defined.

Another approach for mitigating transient errors is the use of redundance. Replicating hardware, as is in N-modular redundancy, can both detect and correct transient faults in hardware. In N-modular redundancy, N replicas produce a result, and the result produced by a majority of replicas is accepted as correct. The N-modular redundant circuit will produce correct results as long as a majority of replicas produces the correct result. However, N-modular redundancy is expensive in terms of area. It requires N times the area of a single replica for whichever structures are replicated. To avoid ties, at least 3 replicas are required, leading to a 3× increase in area for structures to be replicated.

### BRIEF DESCRIPTION OF THE FIGURES

Some examples of apparatuses and/or methods will be described in the following by way of example only, and with reference to the accompanying figures, in which

FIG. 1a shows a schematic diagram of an example of an apparatus or device for correcting transient errors in a computational device, and of a computer system comprising such an apparatus or device;

FIG. 1b shows a flow chart of an example of a method for correcting transient errors in a computational device;

FIG. 2a shows a schematic diagram of an example of an apparatus or device for generating a configuration of a computational device, and of a computer system comprising such an apparatus or device;

FIG. 2b shows a flow chart of an example of a method for generating a configuration of a computational device;

FIG. 3 shows a diagram of a recovery flow for recovering from transient failures;

FIG. 4 shows a schematic diagram of an example graph and corresponding state during recovery; and

FIG. 5 shows a diagram of simulation results for workload kernels.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

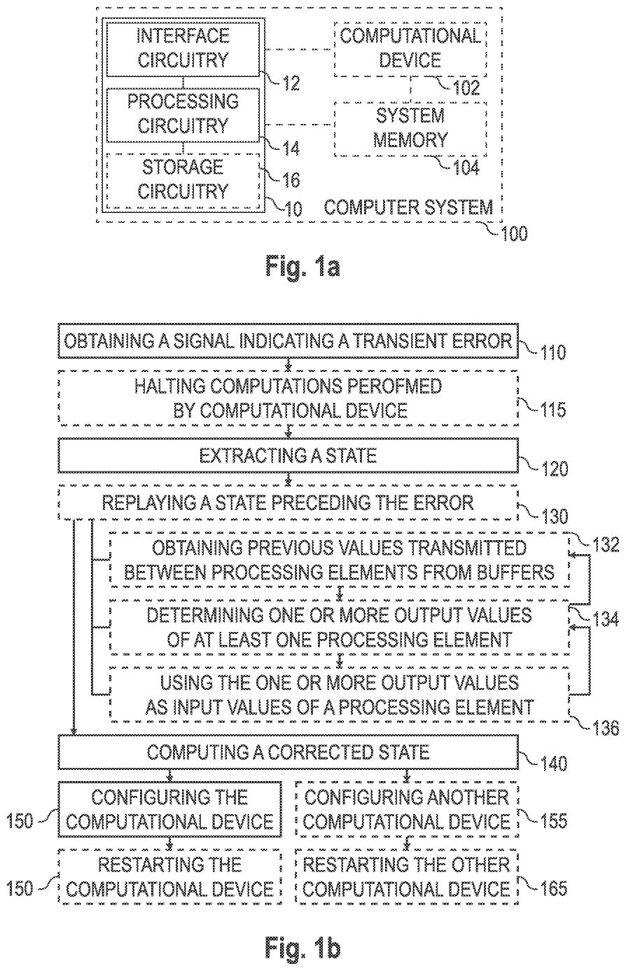

FIG. 1a shows a schematic diagram of an example of an apparatus 10 or device 10 for correcting transient errors in a computational device 102, and of a computer system 100 comprising such an apparatus or device and computational device 102. Moreover, the computer system 100 may further comprise system memory 104, which may be coupled with both the apparatus 10 or device 10 and the computational device 102. The apparatus 10 comprises circuitry to provide the functionality of the apparatus 10. For example, the circuitry of the apparatus 10 may be configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the computer system 100 comprising the apparatus or device 10, such as the computational device 102) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is to obtain a signal indicating that a transient error has been detected in the computational device 102, with the computational device being configured to perform computations using processing elements and connections between the processing elements. The processing circuitry 14 or means for processing 14 is to extract a state of the computational device. The state comprises at least one of present and previous values transmitted via the connections between the processing elements and state contained within the one or more processing elements. The processing circuitry 14 or means for processing 14 is to compute a corrected state of the computational device based on the state extracted from the computational device. The processing circuitry 14 or means for processing 14 is to configure a computational device with the corrected state.

FIG. 1a further shows the computer system 100 with one or more processors 14 (which may implement the processing circuitry 14 or means for processing 14 of the apparatus 10 or device 10), and with the computational device 102, which is separate from the one or more processors. In other words, the computational device 102 may be separate from a central processing unit (CPU) 14 of the computer system. For example, the computational device 102 may be an add-in card or a co-processor included in the computer system.

FIG. 1b shows a flow chart of an example of a corresponding method for correcting transient errors in the computational device. The method comprises obtaining 110 the signal indicating that a transient error has been detected in the computational device. The method comprises extracting 120 the state of the computational device. The method comprises computing 140 the corrected state of the computational device based on the state extracted from the computational device. The method comprises configuring 150/155 a computational device with the corrected state.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

The present disclosure relates to a concept for mitigating transient errors in computational devices, and in particular in graph-based computational devices, i.e., computational devices that perform computations using processing elements that are interconnected via connection (i.e., channels) between the processing elements, with the processing elements being the nodes of the graph and the connections/channels being the edges of the graph. Such computational graphs are often implemented using spatial computational devices, such as Coarse-Grained Reconfigurable Arrays (CGRA) or Field-Programmable Gate Arrays (FPGAs), which can implement and execute programs by mapping parts of the program code to different regions of a spatial hardware device. Accordingly, the computational device may have a spatial architecture, and/or be a spatial computational device. The spatial computational device may be one of a CGRA, a one-time programmable Application Specific Integrated Circuit (ASIC), and an FPGA. Such spatial computational devices comprise spatially separated computing circuitry that can be controlled independently of each other.

Computational devices contain state. Architecturally visible state is the state specified to be present in architecture diagrams and documentation. Additionally, a computational device has implicit state which is state that is not necessarily visible to the outside world. Implicit state might be present as side effect of how the computational device is implemented or might be added intentionally, for example to improve availability.

When the computational device's state becomes corrupted due to a transient fault, the current state, whether architecturally visible or not, can be used to reconstruct a valid state from which the computation can be restarted. Various examples of the present disclosure relate to a concept for masking transient faults in a computational graph by inferring a corrected state from a post-fault graph state. The proposed concept is a concept for recovering a valid state from a corrupted state after a transient fault by replaying architectural execution using portions of the corrupted state. In particular, it provides an approach for constructing a valid state of a computational device from a corrupted state using the current implicit and architecturally visible state by inferring correct values of corrupted state from uncorrupted parts of implicit and architecturally visible state.

Because the proposed concept uses state already available in the architecture, little additional hardware overhead is required. The proposed concept can apply to any architecture, but it is most useful in fine-grained spatial architectures where architectural state is plentiful and where traditional repair techniques are infeasible because of hardware overhead.

In the proposed concept, a spatial architecture can repair faults by systematically searching latent state of the system to recreate state at the time of the fault. For example, latent state can be found in buffers, pipeline/hyperflex registers, memory system buffers, memory itself, and operation state (such as, sequencer counts). Arrangement of operations used in the graph can be changed to improve recoverability. Moreover, extra storage can be added to improve recoverability.

The process starts when the computational device detects occurrence of a transient error, i.e., a non-permanent error that has an underlying cause that resolves itself or that occurs only once. For example, the transient error may be a bit-flip, i.e., the random changing of a bit in memory from 1 to 0, or vice versa. When such an error occurs, it may be detected by error-detection functionality of the computational device, which may be based on using parity information or a residue. Using the error-detection functionality, the computational device may detect such transient errors, and provide the signal indicating that a transient error has been detected in the computational device to the host, i.e., the computer system, and in particular the apparatus 10 of the computer system. For example, the signal may trigger an interrupt at the computer system 100 or apparatus 10. In addition, the computational device may comprise a functionality for halting execution of the computational graph (or of a sub-graph thereof), i.e., for halting the computations being performed by the computational device, which may be triggered by the error-detection functionality as well. Alternatively, the computations may be halted by the computer system host/apparatus, in response to the signal. In other words, the processing circuitry may halt the computations being performed by the computational device, e.g., by instructing the computational device to halt the computations. Accordingly, as shown in FIG. 1b, the method may comprise halting 115 the computations being performed by the computational device,

When this signal is received from the computational device, extraction of the state of the computational device is triggered. As outlined above, the computational device comprises architecturally visible state and implicit state. This state comprises at least one of present values transmitted via the connection between the processing elements, previous values transmitted via the connections between the processing elements and state contained within the one or more processing elements. In particular, the state may comprise the content of memory (e.g., random access memory, which may be used as buffers for values transmitted via the connections, or memory of the processing elements). The state may be (partially) extracted so that corrupted parts of the state can be corrected. In other words, the state may be extracted from the computational device when a fault (i.e., the transient error) is detected so that a valid state can be computed from the corrupt state on a different system. For example, the state may be read out from the computational device via a configuration interface of the computational device.

This state, which is invalid, may now be corrected on the host device. For example, the processing circuitry may replay the state preceding the error when computing the corrected state. Accordingly, as further shown in FIG. 1b, the method may comprise replaying 130 the state preceding the error when computing the corrected state. For example, the processing circuitry may replay the state preceding the error in a simulator or debugger to compute the corrected state. As failures are rare compared to failure-free operation, performing the recovery is generally not a major impact to performance. Doing the recovery on the host in a simulator/debugger is less expensive because it requires no specialized hardware. In some cases, however, the speed of the recovery may be an important key performance indicator. In this case, some or all of the state recovery, and in particular the replaying of the state preceding the error, may be done on a computational device (such as the computational device 102). While this may increase the implementation complexity, recovery of the state may be sped up.

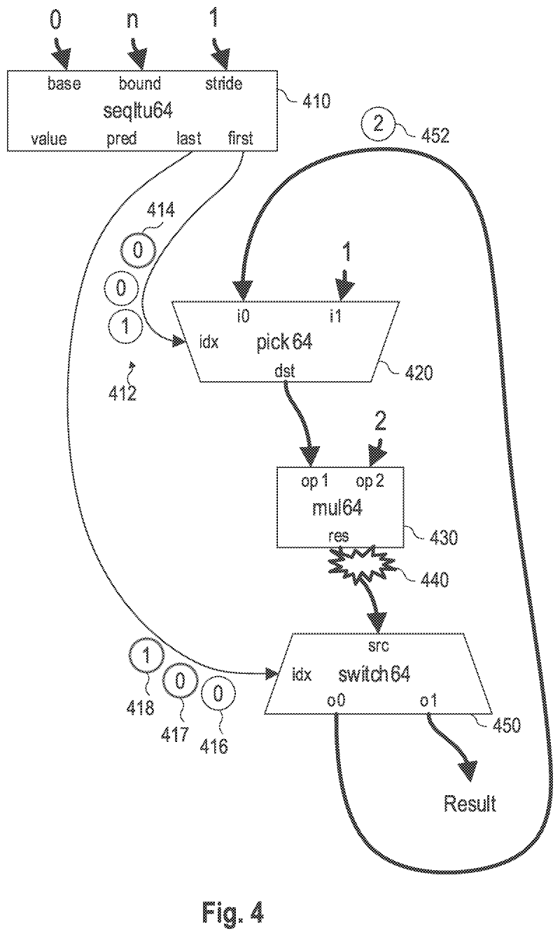

To replay the state, previous computations may be repeated, based on previous values. Some values do not change, e.g., when a computation is (partially) being performed based on constant, literal values, e.g., as shown in FIG. 4. In FIG. 4, operation seqltu64 (410) has three inputs, with the base input and the stride input being provided literal inputs 0 and 1, respectively. The pick64 operation 420 has three inputs, with one of them (i1) being provided literal input 1. The op2 input of the mul64 operation 430 is provided literal input 2 etc. These literal input can be reconstructed from the configuration of the computational device.

In addition, the values being transmitted via the connection (i.e., channels) between the processing elements may be reconstructed. In addition to the values currently active on the graph (i.e., currently transmitted via the connections), older values may be reconstructed from non-overwritten memory in buffers between the processing elements. For example, data channels between processing elements may be buffered. Such buffers may retain old values in a First-In First-Out (FIFO) manner, with the old values being retained until overwritten with a newer value. Consequently, the processing circuitry may obtain previous values transmitted via the connections between the processing elements from buffers included in the respective connections between the processing elements, for example from buffers having a first-in, first-out mechanism. Accordingly, as further shown in FIG. 1b, the method may comprise obtaining 132 previous values transmitted via the connections between the processing elements from buffers included in the respective connections between the processing elements. In particular, the processing circuitry may obtain previous values transmitted via the connections between the processing elements from non-overwritten buffer entries of buffers included in the respective connections between the processing elements.

In some examples, this extraction of previous values may be aided by the configuration of the computational device. For example, the processing circuitry may obtain previous values transmitted via the connections between the processing elements from buffers being inserted, or buffers having an increased size, for the purpose of recoverability of the previous values. In general, the buffers inserted for the purpose of recoverability may be “normal” buffers. In this case, if the buffer ever gets completely full with live values, then old values that are used for recovery will be overwritten. To avoid such scenarios, a buffer may be configured so that only a certain number of slots are usable for live values and the remaining values may be old, consumed tokens that can only be used for recovery. Thus, at least a subset of the buffers being inserted for the purpose of recoverability comprise a portion of memory being reserved for the purpose of recoverability. For example, the respective buffer may be a FIFO buffer that is implemented as a ring buffer, with new values being written to a portion of memory indicated by a write pointer and the next value to be output being stored in a portion of memory indicated by a read pointer. A pre-defined maximal distance between the read pointer and the write pointer indicates the depth of the buffer. However, the buffer may include more memory portions than required for implementing the depth of the buffer, with the additional memory portions causing an additional delay before a memory portion that has been read out (when outputting the value) is next overwritten. As long as the memory has not been over-written, its content (i.e., a value previously stored in the FIFO buffer) can be restored.

In addition, knowledge about the operation being performed by the respective processing elements, and their current state, may be used to restore previous inputs and/or outputs of the respective processing elements. For example, the current state of processing elements that change state in a predetermined (i.e., deterministic) way may be used to deduce previous outputs from the current state and the input values consumed and/or number of output values produced. This is particularly the case with stateful processing elements, i.e., processing elements that have a state (which may be a counter, a previous result etc.). For example, the processing circuitry may determine, for at least one processing element having a stateful and deterministic behavior, one or more output values based on the state of the computational device, and to compute the corrected state based on the one or more output values. Accordingly, as further shown in FIG. 1b, the method may comprise determining 134, for at least one processing element having a stateful and deterministic behavior, one or more output values based on the state of the computational device and computing 140 the corrected state based on the one or more output values. In particular, the processing circuitry may determine, for at least one processing element having a stateful and deterministic behavior, one or more previous output values based on at least the current state of the processing element and one or more current input values of the processing element. For example, the current state and the current input values may be used to deduce the one or more previous output values, by determining a previous state of the processing element from the current state (and the current input values). For example, if the processing element is a sequence operator (such as seqltu64 in Fig.), it outputs a sequence of values, depending on the base (i.e., the starting value), the bound (i.e., the maximal value) and the stride (i.e., the stride size between successive output values). For example, at base 0 and stride 1, the output (i.e., the value output of seqltu64) is 0, 1, 2, 3, 4, 5, . . . , at base 2 and stride 2, the output is 2, 4, 6, 8, . . . If the state, such as the current value, and the input values, which generally do not change in this example, are known, e.g., 5 or 8, the previous values output by the sequence, and the previous state, may be derived from the current state and the current input values, by reversing the sequence based on the stride (and base). The processing element may then be set to the earlier state when replaying the state.

In some cases, previous values transmitted via a connection may not be available, as no buffer was used for the connection, and as the processing elements concerned do not contain state. In this case, the values that could be reconstructed can be used to repeat the operations. For example, the processing circuitry may compute valid input values for a processing element based on the state of the computational device, and compute the corrected state based on the valid input values. Accordingly, the method may comprise computing 136 valid input values for a processing element based on the state of the computational device. When doing this, the end goal is to calculate input values for the processing element at which output transient errors occurred, and to use the now correct output of said element to propagate the correct value to downstream processing elements. Consequently, the processing circuitry may compute valid input values for a processing element having output a value modified by the transient error based on the state of the computational device, and compute the corrected state based on the valid input values. Accordingly, the method may comprise computing 136 valid input values for a processing element having output the value modified by the transient error based on the state of the computational device, and computing the corrected state based on the valid input values.

In some cases, the input values reconstructed from literal inputs and buffers may suffice. In some cases, however, the inputs of upstream processing elements may be reconstructed, to provide their output values as input values to the processing element having output the value modified by the transient error. Accordingly, the processing circuitry may determine, for at least one processing element, one or more output values, and to use the one or more output values as one or more input values to one or more connected processing elements. Accordingly, as shown in FIG. 1b, the method may comprise determining 134, for at least one processing element, one or more output values, and using 136 the one or more output values as one or more input values to one or more connected processing elements. In some cases, the input values may suffice, as some (stateless) processing elements produce deterministic output values for a given set of inputs. Consequently, the processing circuitry may determine, for at least one processing element having a stateless and deterministic behavior, one or more output values by determining one or more input values of the at least one processing element based on the state of the computational device. Accordingly, the method may comprise determining 134, for at least one processing element having a stateless and deterministic behavior, one or more output values by determining one or more input values of the at least one processing element based on the state of the computational device. However, some processing elements may have a stateful and deterministic behavior. In this case, the (previous) input values and (previous) state of the stateful processing element may be derived from the state of the computational device, and the output(s) provided by the processing element based on the derived input(s) and state may be used as input(s) to one or more downstream processing element.

The aim of the proposed measures is to achieve a valid state. However, in many cases, major portions of the computational graph are not affected by the transient error—the state associated with these portions of the computational graph may be left untouched (e.g., not extracted in the first place). The proposed concept may be applied to processing elements and values that are downstream from the transient error (or part of a circular relationship). In other words, the valid state may be determined for (all) processing element(s) affected by the transient error. As halting the computational graph may generally take multiple clock cycles, the processing circuitry may determine affected processing elements and values from the configuration of the computational device and from information on a halting time of the respective processing elements of the computational device.

Once one or more of the above measures have been performed, a valid state may have been reached, i.e., a corrected (i.e., valid) state of the computational device has been computed based on the state extracted from the computational device. This corrected state is now used to configure a computational device. In many cases, the computational device being configured with the corrected state may be the computational device, on which the transient error has occurred. Thus, the processing circuitry may selectively correct the state of the computational device in place based on the corrected state. For example, the state may be corrected in place without extraction, i.e., by overwriting only part of the state of the device, while leaving the rest of the state intact. Alternatively, the processing circuitry may replace the (entire) state of the computational device with the corrected state. After the state of the computational device is valid again, the computations may be restarted. In other words, the processing circuitry may restart the computations after configuring the computational device with the corrected state, e.g., by instructing the computational device to restart the computations. Accordingly, as shown in FIG. 1b, the method may comprise restarting 160 the computations after configuring the computational device with the corrected state. In summary, processing circuitry may configure the computational device with the corrected state, and to restart the computations on the computational device after configuring the computational device with the corrected state. In this case, computation may be restarted from the corrected state after the state is reloaded to the original computational device.

Alternatively, another computational device may be used to continue the computations. For example, the processing circuitry may configure a different computational device with the corrected state and restart the computations on the different computational device after configuring the different computational device with the corrected state. Accordingly, as shown in FIG. 1b, the method may comprise configuring 155 a different computational device with the corrected state. The method may comprise restarting 165 the computations on the different computational device after configuring the different computational device with the corrected state. In this case, the processing circuitry may replace the state of the other computational device with the corrected state. In addition, if the computational device has been operated with a different configuration before, also the configuration of the computational device may be replaced. In effect, the computation may be restarted from the corrected state on a different computational device. As another alternative, the corrected state may be run in a simulator or debugger.

The proposed concept has been reduced to practice in simulation models of for the Configurable Spatial Architecture (CSA), a coarse-grained configurable architecture. The proposed concept also directly applies to FPGAs which implement similar compute graph structures on top of the FPGA fine-grained fabric, or other spatial architectures, including application-specific devices.

Simulation results show that for many graphs this approach has a high enough success rate to enable an Exascale (thousands of cooperating devices) system to meet availability targets and more than cover the needs of all smaller systems. These results only take advantage of the latent state, and do not yet incorporate re-arranging or inserting additional storage to boost recoverability.

For example, the system memory 104 may be embodied as any type of memory device capable of (temporarily) storing data, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the proces sing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a server computer system, i.e., a computer system being used to serve functionality, such as the functionality provided by the computational device, or a workstation computer system 100.

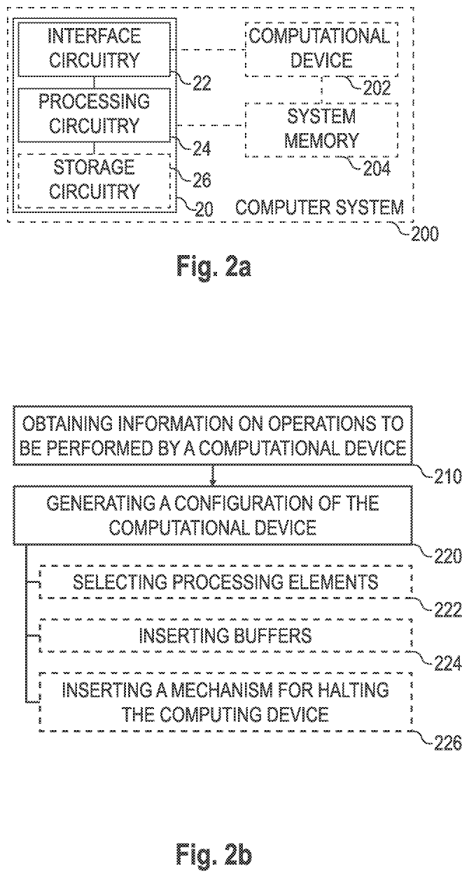

More details and aspects of the apparatus, device, method, of a corresponding computer program, the computational device and of the computer system are mentioned in connection with the proposed concept or one or more examples described above or below (e.g., FIGS. 2a to 5).

The apparatus, device, method, computer program, computational device and computer system may comprise one or more additional optional features corresponding to one or more aspects of the proposed concept, or one or more examples described above or below.

While FIGS. 1a and 1b relate to a concept for handling transient errors, FIGS. 2a and 2b relate to improvements in the configuration of the computational device, to facilitate reconstruction of previous values.

FIG. 2a shows a schematic diagram of an example of an apparatus 20 or device 20 for generating a configuration of a computational device 202, and of a computer system 200 comprising such an apparatus or device (and, optionally, the computational device 202). While the computational device 202 is shown to be part of the computer system 200, it is an optional component, as generating a configuration for the computational device 205 does not require having a computational device installed in the computer system that generates the configuration. Moreover, the computer system 200 may further comprise system memory 204, which may be coupled with both the apparatus 20 or device 20 and the computational device 202. The apparatus 20 comprises circuitry to provide the functionality of the apparatus 20. For example, the circuitry of the apparatus 20 may be configured to provide the functionality of the apparatus 20. For example, the apparatus 20 of FIGS. 2a and 2b comprises interface circuitry 22, processing circuitry 24 and (optional) storage circuitry 26. For example, the processing circuitry 24 may be coupled with the interface circuitry 22 and with the storage circuitry 26. For example, the processing circuitry 24 may provide the functionality of the apparatus, in conjunction with the interface circuitry 22 (for exchanging information, e.g., with other components inside or outside the computer system 200 comprising the apparatus or device 20, such as the computational device 202) and the storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIGS. 2a and 2b comprises means for processing 24, which may correspond to or be implemented by the processing circuitry 24, means for communicating 22, which may correspond to or be implemented by the interface circuitry 22, and (optional) means for storing information 26, which may correspond to or be implemented by the storage circuitry 26. In general, the functionality of the processing circuitry 24 or means for processing 24 may be implemented by the processing circuitry 24 or means for processing 24 executing machine-readable instructions. Accordingly, any feature ascribed to the processing circuitry 24 or means for processing 24 may be defined by one or more instructions of a plurality of machine-readable instructions. The apparatus 20 or device 20 may comprise the machine-readable instructions, e.g., within the storage circuitry 26 or means for storing information 26.

The processing circuitry 24 or means for processing 24 is to obtain information on operations to be performed by the computational device. The processing circuitry 24 or means for proces sing 24 is to generate a configuration of the computational device by selecting processing elements and connections between the processing element to be used by the computational device based on the operations to be performed by the computational device. At least one of the processing elements and the connections between the processing element are configured to improve recoverability of a current or previous state of the computational device.

FIG. 2b shows a flow chart of an example of a corresponding method for generating the configuration of the computational device. The method comprises obtaining 210 the information on the operations to be performed by the computational device. The method comprises generating 220 the configuration of the computational device by selecting processing elements and connections between the processing element to be used by the computational device based on the operations to be performed by the computational device.

In the following, the functionality of the apparatus 20, the device 20, the method and of a corresponding computer program is illustrated with respect to the apparatus 20. Features introduced in connection with the apparatus 20 may likewise be included in the corresponding device 20, method and computer program.

In contrast to FIGS. 1a and 1b, where the handling of transient errors having occurred is discussed, the apparatus and device of FIG. 2a, the method of FIG. 2b, and a corresponding computer program relate to a concept for preparing the configuration of the computational device for such a case, by including mechanisms for supporting transient error handling in the configuration of the computational device.

In general, the generation of configurations (i.e., the spatial fabric) for computational devices, and in particular for spatial computational devices, such as FPGAs, CGRAs, or one-time programmable ASICs is well known. Therefore, the present discussion concentrates on features not commonly included in such configurations.

The generation of a configuration (i.e., a spatial) fabric is the process of mapping a functionality, which may be defined by a high-level code, to available processing elements of the computational device. Similar to compiling high-level code to machine-code, the functionality defined by the high-level code may be mapped to operations, which may be performed by the processing elements of the computational device. Data dependencies between the operations are then mapped to connections (i.e., channels) between the processing elements.

During this process, the recoverability of values may be improved both by selecting (stateful) processing elements, from which state can be extracted, and by including or configuring buffers with an eye on recoverability. For example, processing graph topology may be improved or optimized to enhance recoverability due to implicit and/or explicit state. Thus, the processing circuitry generates the configuration of the computational device by selecting processing elements and connections between the processing element to be used by the computational device based on the operations to be performed by the computational device, with at least one of the processing elements and the connections between the processing element being configured to improve recoverability of a current or previous state of the computational device.

As outlined above, one of the levers for improving recoverability are the processing elements being used. For example, some types of processing elements may facilitate recoverability, e.g., as they have a stateful and deterministic behavior, which allows reversal to a previous state, and thus determination of previous output values. In other words, the selection of processing element type may be influenced by recoverability. Thus, the processing circuitry may perform the selection of a processing element among a group of functionally equivalent processing elements based on the recoverability of the current or previous state of the computational device. Accordingly, as further shown in FIG. 2b, the method may comprise performing the selection 222 of a processing element among a group of functionally equivalent processing elements based on the recoverability of the current or previous state of the computational device.

Another lever is the inclusion and configuration of buffers. In general, buffers are included in spatial computational devices for various reasons, such as use of different clock domains, synchronization etc. However, not every connection between adjacent processing elements requires a buffer, so the buffer is often omitted, and, if a buffer is used, its size is usually kept at or near a minimum. Both measures are taken to improve or optimize the amount of memory or number of processing elements required in the computational device. To improve recoverability, it is beneficial to retain additional state within the computational device, which, in turn, may require said state to be stored in a memory within the computational device. Thus, buffers may be used to retain values for recoverability. For this purpose, additional buffers may be included for connections that do not strictly require a buffer, and the buffer size of existing buffers may be increased, along with a mechanism for delaying overwriting the buffers. The latter is in particular the case with FIFO-style buffers (i.e., at least some buffers may have a first-in, first-out mechanism), which may be implemented as ring buffers. When ring buffers are used, their capacity may be increased to delay overwriting the previous values.

Thus, at least some buffers (being inserted) have multiple entries, so that a previous state can be received from a non-overwritten buffer entry in the respective buffer.

Thus, the processing circuitry may include (or extend) buffers in the connections between the processing elements to improve the recoverability of the current or previous state of the computational device. Accordingly, the method may comprise including 224 (or extending) buffers in the connections between the processing elements to improve the recoverability of the current or previous state of the computational device. For example, at least a subset of the buffers being inserted for the purpose of recoverability comprise a portion of memory being reserved for the purpose of recoverability. For example, at least one of architecturally visible buffers and buffers that are not architecturally visible may be added to the spatial computation graph to increase recoverability. In other words, the buffers may be included as architecturally visible buffers and/or as architecturally invisible buffers.

However, the inclusion of buffers has multiple costs, such as the aforementioned additional memory, but also an additional delay being caused by the buffers, as the values are not transmitted directly between processing elements, but rather first stored in the buffer and then read out and forwarded to the downstream processing element. In effect, the inclusion of buffers may be performed based on a tradeoff between additional latency caused by the buffers and improvements to recoverability of the current or previous state of the computational device. In particular, the inclusion of buffers may be performed both to aid in recoverability and to balance capacity with latency in reconvergent paths. For example, buffer placement may be co-optimized or co-improved to balance latency and buffering across re-convergent paths and while also enhancing recoverability. Being able to co-optimize buffer placement for recoverability and for balancing capacity with latency of reconvergent paths will allow buffers to serve multiple purposes. There are other cases where buffer is inserted for other reasons (for example during place and route, long signal paths have to be broken down into shorter paths). More generally, it is generally possible to trade off or co-optimize buffer placement for recoverability and any of the other reasons for buffer placement. Moreover, there are generally other considerations as well, such as the size of the blocks of memory available, memory requirements of some processing elements (for storing state) etc. Thus, the buffers may be configured to increase recoverability and satisfy other purposes simultaneously. For example, the buffers may be configured to enhance recoverability or configured for other purposes.

In addition to the aforementioned selection of the processing elements and the configuration of the buffers, a mechanism may be included to speed up halting the execution of computations in case of a transient errors, so that the transient error does not propagate far. For example, the processing circuitry may insert a mechanism for halting the computations being performed by the computational device upon detection of a transient error. Accordingly, as shown in FIG. 2b, the method may comprise inserting 226 a mechanism for halting the computations being performed by the computational device upon detection of a transient error. This mechanism may be closely linked to the error detection mechanism(s) used in the first place to detect the transient errors. For example, the processing elements may include one or more error detection mechanisms, which may be based on parity checks and/or based on residue. In some examples, the processing elements being used to perform the operations may include an error detection mechanism. For example, rather than having a separate component for detecting errors, the error detection may be integrated into some, but not all of the processing elements. Error checking circuitry has some cost, and so omitting it from some processing elements reduces cost. Accordingly, the selection of the processing elements may be further based on whether to use a processing element with or without error detection, e.g., in such a way as to increase the likelihood of recovery, and in particular based on a tradeoff between increasing the likelihood of recovery and increasing the costs. In other words, the processing elements may further be selected with or without an error detection mechanism based on a desired granularity of the error detection and/or based on a desired delay of detecting transient errors. Alternatively, error detection nodes/circuits (i.e., processing elements) may be inserted independently of the processing elements. The one or more error detection mechanisms may both provide the signal indicating that a transient error has been detected, and locally trigger the mechanism for halting the computations.

For example, the system memory 204 may be embodied as any type of memory device capable of (temporarily) storing data, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the storage circuitry 26 or means for storing information 26 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 200 may be a server computer system, i.e., a computer system being used to serve functionality, such as the functionality provided by the computational device, or a workstation computer system 200.

More details and aspects of the apparatus 20, device 20, computer system 200, method and of a corresponding computer program are mentioned in connection with the proposed concept or one or more examples described above or below (e.g., FIG. 1a to 1b, 3 to 5). The apparatus 20, device 20, computer system 200, method and corresponding computer program may comprise one or more additional optional features corresponding to one or more aspects of the proposed concept, or one or more examples described above or below.

When a computational graph detects an error caused by a fault, computation halts. Spatial fabric state often contains the past inputs as well as the present inputs for a given computation. This proposed concept provides a method to correct errors in a graph by analyzing the graph to infer that past state and using this state to re-compute an error-free calculation. After the halt, the proposed concept uses the state that exists in the graph, independent of fault-tolerance features, to recompute uncorrupted inputs to computational elements (i.e., processing elements) that detected the error. When the inputs can be recomputed, the erroneous computation can be replayed with correct inputs, and a correct result re-inserted into the graph state to repair the error. Upon correction, normal execution may be resumed.

The proposed concept can correct graph state without resorting to N-modular redundancy and heavy hardware overhead. Low hardware overhead is essential for feasibility in fine-grained spatial architectures, where additional hardware may be replicated hundreds-of-thousands-to-millions of times in a single chip. Inferring pre-fault state allows extensive and efficient error correction without the cost of hardware-based error correction schemes, which is especially valuable in a fine-grained architecture like FPGA. Being able to recover from transient faults increases system availability—which is especially important for large scale deployments, systems requiring high availability, or systems with operational safety requirements.

While the proposed analysis can be hardware accelerated, it may also be done by an external agent such as software. This external agent analysis may require very little hardware support. If errors remain relatively rare, the performance associated with the recovery flow can be considered low, without affecting the user experience.

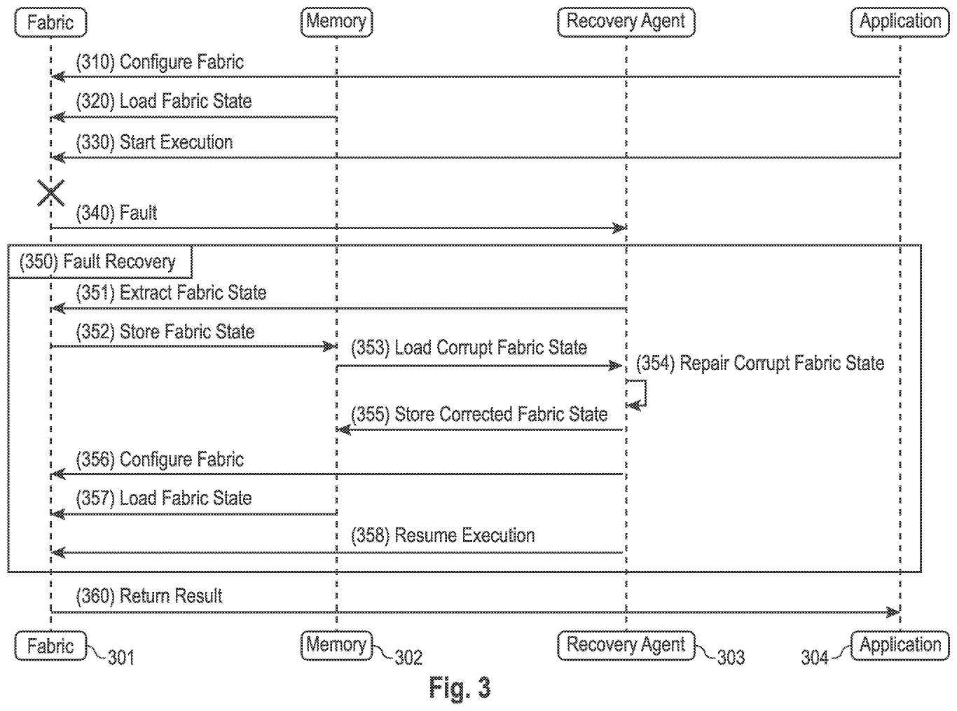

FIG. 3 shows a diagram of an example recovery flow for recovering from transient failures. FIG. 3 may show an example of the proposed concept being used to recover from transient failures. For example, the recovery flow may be used by the apparatus 10, device 10, method and computer program of FIGS. 1a and 1b. In particular, the recovery agent 303 may be implemented by the apparatus 10, device 10, method and computer program of FIGS. 1a and 1b.

As shown in FIG. 3, an application 304 configures 310 the fabric, which causes the fabric 301 to load initial (fabric) state from memory 302. Then the application starts 330 execution of the computation on the fabric. When a fault occurs, the fabric signals 340 a recovery agent 303 to begin fault recovery.

Fault recovery 350 begins when the Recovery Agent is notified of a fault and ends when execution resumes. As shown in the numbered tasks in the figure, the Recovery Agent begins by (351) signaling the fabric to extract the current fabric state. This state includes both architecturally visible and implicit state. The Extract Fabric State message (351) in FIG. 3 is a message to the device telling it to store its state in memory. The extraction does not necessarily change the computational device's state. The fabric then (352) writes the state to memory, and the Recovery Agent (353) loads the corrupt state from memory. The Recovery Agent (354) analyzes the corrupt state, as described below in “Repairing Corrupt Fabric State”, correcting it if possible, and (355) writes the corrected fabric state back to memory. The Recovery Agent then (356) configures the fabric to use the corrected state, and the fabric (357) loads the corrected state from memory. The Configure Fabric message (356) in FIG. 3 is the message that tells the device what to do when configuring the fabric to use the corrected state, i.e., whether the fabric should be partly overwritten in place or entirely replaced. For example, it may tell the device which parts of the state need to be loaded (could be all or partial). Then the device loads the state (357) that was described in the message from the Recovery Agent in (356).Finally, the recovery agent (358) signals the fabric to resume execution, using the corrected fabric state. Finally, the result is returned 360. This flow is transparent to the application, and a corrected error results in no impact, other than momentary performance loss, to the application.

Other examples are possible. For example, the graph may automatically write state to memory without explicit notification from the recovery agent, or the recovery agent may directly read parts of the state needed to repair corrupt state directly from the fabric.

In the following, an approach for repairing corrupt fabric state is shown. A major part of the proposed concept is to compute correct fabric state from an existing, but partially corrupted fabric state. One possible implementation of the Recovery Agent to recover state is with a two-phase recursive algorithm, which searches for uncorrupted state which can be used to recompute and replace corrupted values. The agent may achieve this by following basic fabric execution rules in reverse to locate necessary data.

Pseudo code describing how to repair graph state is shown below. For example, the pseudo code may provide an example implementation of operations 130-136 shown in FIG. 1b. When an operation's output is found to be corrupt, the Recovery Agent may call the recover_op_outputs function, passing it the failed operation and an age parameter of 1, indicating to return the most recent set of outputs from the operation.

The notion of age is used to trace values through the fabric state, allowing the relation of operands and results. Due to rich state available in most spatial fabrics, many generations of values (corresponding to several ‘ages’) may usually be available in the fabric state.

```
recover_op_outputs(Operation op, int age)
  if op.can_derive_previous_state(age)
    return Found, op.previous_state(age)
  foreach i in op.num_inputs
    input_age = get_input_age(op, i, age)
    found[i], inputs[i] = recover_channel_output(op.input[i], age)
  if all(found)
    found, outputs = op.exec(inputs)
  else
    found = NotFound
    outputs = nil
  return found, outputs
recover_channel_output(Channel ch, int age)
  if ch.has_consumed_token(age)
    return Found, ch.consumed_token(age)
  age = age + ch.num_puts − ch.num_gets
  found, op_outputs = recover_op_outputs(ch.input_op, age)
  return found, op_outputs[ch.input_op_port]
```

The recover_op_outputs function first checks if the desired previous state, age tokens before the current state, can be computed from the current state (which may implement operations 130, 134 of FIG. 1b). Stateless operations like add or subtract do not keep state across invocations. Previous state might not be derived from current state for such operations. When an operation with state has failed, its current state is likely to be corrupt and current state might not be derived from it. In contrast, stateful operations that have not failed may be able to produce the desired value. For example, an operation that counts through a sequence of numbers can compute a previous output in the same sequence, given the current state and the age of the desired previous value. In some cases, memory accesses can be repeated to produce a previous output. When a result can be derived, op.can_derive_previous_state(age) is true. The recover_op_outputs function returns a Found indicator, to say that the result was found, and a collection of the correct outputs of the operation (implementing operation 134 of FIG. 1b).

When state cannot be directly derived from the current state, recover_op_outputs calls recover_channel_output (which may implement operation 132 of FIG. 1b) to search the operation's channels for previously consumed input values. The age passed to recover_op_outputs is based on the operation, behavior of the input on the operation, and age of the output being sought. A stateless, unpipelined operation may search for an input with the same age as the output. For a pipelined operation, get_input_age increases the age by the number of tokens currently in the pipeline. Stateful operations, especially those for which a single input produces multiple outputs have a more complex relation between input age and output age.

If recover_channel_output finds the desired output from the channel for all the operation's inputs, then recover_op_output executes the operation on the found inputs (implementing operation 136 of FIG. 1b), which produces a corrected value that can be used to repair the fabric state. Otherwise, recovery may fail.

To recover a previous channel output, recover_channel_output may first look in the channel state for previous values. Previous values might be available due to the channel implementation retaining old values as a side effect of how the channel is implemented, or certain channels might be configured to retain some previous values to enhance recoverability. When the previously consumed token is found, the Found indicator may be returned along with the previous value.

When the desired value is not stored directly in the channel, the Recovery Agent calls recover_op_outputs for the operation that is an input to the channel. The age passed to recover_op_outputs is increased by the number of additional tokens output to the channel from the upstream operation. This recursive search may trace back values across the program graph and may result in many re-computations of predecessor values, all of which ultimately result in either the calculation of the desired value or a failure. The result of the search is returned to the caller.

The pseudo-code listed above is one algorithm to recover the graph. Alternatives may reduce the search space by terminating the search early when it is unlikely or impossible to succeed, cache partial search results, or use a different search order to speed the search. Sometimes operations send the same output to multiple inputs, and a previous value might be available by searching operation outputs, as well as inputs.

FIG. 4 gives an example of recovery for a simple graph of the kind produced by high-level synthesis tools for a spatial array (e.g. FPGA or CSA). FIG. 4 shows a schematic diagram of an example graph and corresponding state during recovery. Boxes 410, 420, 430, 450 represent operations, and the lines connecting them represent stateful communications channels (registers, FIFOs). Operations compute results based on tokens 412, 414, 416, 418, 452 arriving at their inputs and write the results to their outputs. In FIG. 4, several operations have literal inputs, shown as numbers, and there is a single input to the graph, n. The explosion icon 440 represents a dynamic soft error.

The graph in FIG. 4 uses seqltu64 (410), pick64 (420), mul64 (430), and switch64 (450) operations to compute 2n, where n is the input parameter to the graph. The seqltu64 operation 410 is a sequencer operation with three inputs, base, bound, and stride. A sequencer counts starting at base in steps of stride while the current count is less than bound. In this case, base and stride are literal 0 and 1 values, respectively, and the channel connected to the seqltu64's bound input receives the n input from the host.

In failure-free operation, computation begins when the host sends an input token the seqltu64 input connected to n. The seqltu64 starts writing values for a new sequence. The seqltu64's first output writes a 1 (412) token for the first value in the sequence and 0 tokens (414) for the subsequent n−1 sequence values. Similarly, the last output writes a 0 token (416; 417) for the first n−1 tokens in the sequence and 1 (418) for that last token in the sequence. These tokens coordinate the action of the pick64 (420) and switch64 (450) operations.

A pick64 operation selects a data token from its i0 input when its idx (index) input is 0, and it selects a token from its i1 input when its idx input is 1. In the example, the seqltu64's (410) first output drives the pick64 (420) to select the literal 1 input from i1 on the first loop iteration. The mul64 (430) multiplies the 1 by a literal 2 token. The last output of the seqltu64 (410) directs the switch64 (450) operation to send the result of mul64 (430) to the pick64 operation's (420) i0 input. After the first iteration the sequencer's first output directs the pick64 (420) to select the token on the pick64's (420) i0 input—the feedback path from the switch64 (450) operation. Tokens circulate around the feedback loop until the seqltu64's (410) last output sends a 0 to send the switch64's (450) output to the feedback path.

In the following, it is assumed that a failure occurs while the graph is executing. Annotations on the communications channels in FIG. 4 show architectural and latent state the proposed concept can use to recover failed graph execution. The circles 412-418, 452 represent tokens in a hypothetical state of the graph state when recovery starts. The tokens with a double contour (414, 417, 418) are “live” tokens—tokens that are visible to the graph that is executing. This graph has three live tokens, a 0 token 414 queued on the pick64 idx input and two tokens 417, 418, a 1 and a 0, queued on the switch64 operation's idx input. The single contour tokens are tokens that have been consumed but remain within the hardware implementing the graph as a side effect of how the hardware is implemented. The token 452 with a value of 2 on the pick64 operation's i0 data input, for example, was consumed by the pick64 and is no longer visible to the running graph. Single contour tokens can be used to replay prior execution and may enable the recalculation of most live graph state (i.e., multi-contour tokens).

Assuming the hardware detects a fault after the mul64 operation produces its first token, the resulting fault pauses graph execution and triggers a graph extraction. The mul64's output token is flagged as corrupt. The Recovery Agent calls recover_op_outputs(mul64,1) to search for the faulty mul64 operation's inputs to determine the correct output.

No state can be derived from the mul64, both because it produced a corrupt output, and because mul64 is a stateless operation, so recover_op_outputs calls recover_channel_output on each of its inputs. The literal 2 on the op2 input is available from the graph configuration for recovery. The algorithm looks for the op1 input operand in the channel connecting the pick64 to the mul64.

In this example, the mul64 has no other multiply operations in its internal pipeline, so the algorithm searches for the most recently consumed token on mul64's input channel. In this example, no token is available. The search continues with the most recently consumed token from the pick64. The pick64 has no internal state, but it can recover tokens from its inputs. The most recently consumed control input determines which data input produced data output being sought. In this case, the pick64 finds a 1 token on the control input, then searches the i0 data input for its most recently consumed token. The token with a value of 2 (452) was most recently consumed and is returned as the pick64 input value. The pick64 returns 2 as its output, and finally mul64 re-computes the output value of 4 from its two inputs, the 2 from the pick64 and the literal 2. The recovery process updates the corrupted token in the mul64's output in the graph state with the corrected value and reloads and runs the graph on the on the spatial array according to the usual execution rules of the hardware. The correction is functionally transparent to the user, although execution is slowed.

The spatial array tool chain can influence recoverability either by taking recoverability into account when laying out the graph or by explicitly inserting storage elements into the graph to improve recoverability. Automatic Buffer Insertion (ABI), also known as buffer balancing in FPGA tool chains, can influence recoverability. Most spatial arrays have fixed-sized storage elements. For example, FPGA block RAM (Random Access Memory) are 8 KB in size. ABI may insert these elements throughout the graph to prevent stalls. Often ABI may require fewer than the full number of entries in the storage element to prevent stalls. The extra buffers, which would normally sit idle, can be used to improve recoverability. For example, recoverability may be used as an optimization criterion in the tool chain, with the user describing to the tool chain how to make optimization tradeoffs.

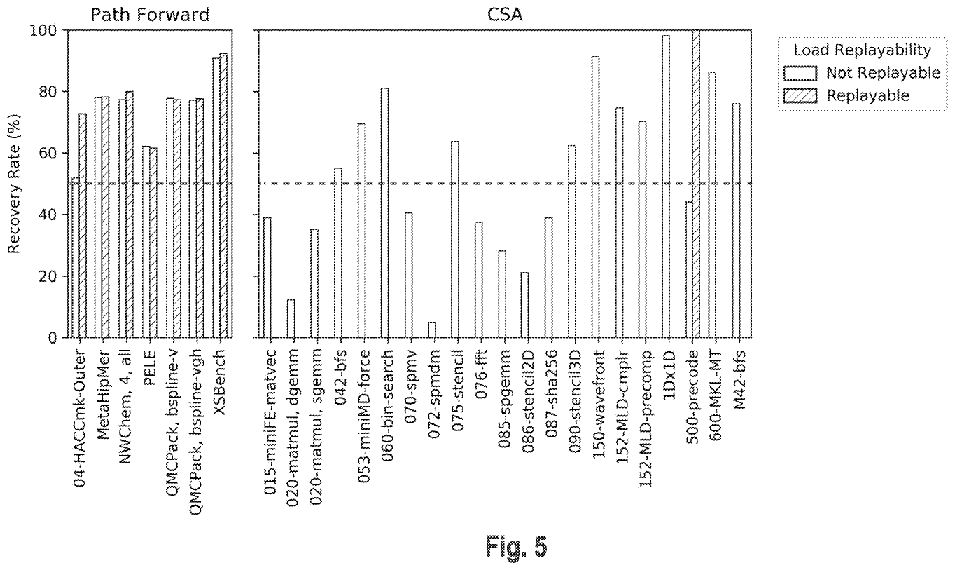

Simulation results, summarized in FIG. 5, show feasibility of the proposed concept with several computational workloads in the context of the CSA spatial array. FIG. 5 shows a diagram of simulation results for workload kernels. The Path Forward benchmarks in the figure below are kernels taken from Department of Energy scientific applications. The CSA workloads are additional kernels commonly found in computationally intensive applications, such as dense matrix multiply, sparse matrix multiply, breadth first search, binary search, sparse matrix-vector multiply, stencils, SHA256, 2D and 3D stencils, and maximum likelihood detection. Empty bars show baseline recovery rate, and striped bars show recoverability with a feature that allows tokens to be recovered from memory when the compiler can prove memory has not changed, or the user asserts they memory has not changed since the original token was read. This feature allows values stored in memory to be used for recovery. Only one workload based on hand-written assembly code has striped bars, due to requiring manual marking for those workloads.

The proposed concept achieves a recovery rate of over 50% for all the Path Forward workloads and more than half the CSA workloads. A 50% recovery rate is expected to be sufficient to provide acceptable availability for an Exascale system (thousands of cooperative nodes) and amply covers smaller systems. Improvements to the software implementation and implementing insertion of buffers for the purpose of recovery are expected to further increase recovery rate.

The aspects and features described in relation to a particular one of the previous examples may also be combined with one or more of the further examples to replace an identical or similar feature of that further example or to additionally introduce the features into the further example.

An example (e.g., example 1) relates to an apparatus (10) for correcting transient errors in a computational device (102), the apparatus comprising interface circuitry (12), machine-readable instructions and processing circuitry (14) for executing the machine-readable instructions to obtain a signal indicating that a transient error has been detected in the computational device, the computational device being configured to perform computations using processing elements and connections between the processing elements. The machine-readable instructions comprise instructions to extract a state of the computational device, the state comprising at least one of present and previous values transmitted via the connections between the processing elements and state contained within the one or more processing elements. The machine-readable instructions comprise instructions to compute a corrected state of the computational device based on the state extracted from the computational device The machine-readable instructions comprise instructions to configure a computational device with the corrected state.

Another example (e.g., example 2) relates to a previously described example (e.g., example 1) or to any of the examples described herein, further comprising that the machine-readable instructions comprise instructions to compute valid input values for a processing element having output a value modified by the transient error based on the state of the computational device, and to compute the corrected state based on the valid input values.

Another example (e.g., example 3) relates to a previously described example (e.g., one of the examples 1 to 2) or to any of the examples described herein, further comprising that the machine-readable instructions comprise instructions to replay the state preceding the error when computing the corrected state.

Another example (e.g., example 4) relates to a previously described example (e.g., example 3) or to any of the examples described herein, further comprising that the machine-readable instructions comprise instructions to replay the state preceding the error in a simulator or debugger to compute the corrected state.

Another example (e.g., example 5) relates to a previously described example (e.g., one of the examples 1 to 4) or to any of the examples described herein, further comprising that the machine-readable instructions comprise instructions to determine, for at least one processing element having a stateful and deterministic behavior, one or more output values based on the state of the computational device, and to compute the corrected state based on the one or more output values.

Another example (e.g., example 6) relates to a previously described example (e.g., example 5) or to any of the examples described herein, further comprising that the machine-readable instructions comprise instructions to determine, for at least one processing element having a stateful and deterministic behavior, one or more previous output values based on at least the current state of the processing element and one or more current input values of the processing element.

Another example (e.g., example 7) relates to a previously described example (e.g., one of the examples 1 to 6) or to any of the examples described herein, further comprising that the machine-readable instructions comprise instructions to determine, for at least one processing element, one or more output values, and to use the one or more output values as one or more input values to one or more connected processing elements.

Another example (e.g., example 8) relates to a previously described example (e.g., one of the examples 1 to 7) or to any of the examples described herein, further comprising that the machine-readable instructions comprise instructions to determine, for at least one processing element having a stateless and deterministic behavior, one or more output values by determining one or more input values of the at least one processing element based on the state of the computational device.

Another example (e.g., example 9) relates to a previously described example (e.g., one of the examples 1 to 8) or to any of the examples described herein, further comprising that the machine-readable instructions comprise instructions to obtain previous values transmitted via the connections between the processing elements from buffers included in the respective connections between the processing elements.

Another example (e.g., example 10) relates to a previously described example (e.g., example 9) or to any of the examples described herein, further comprising that the machine-readable instructions comprise instructions to obtain previous values transmitted via the connections between the processing elements from non-overwritten buffer entries of buffers included in the respective connections between the processing elements.

Another example (e.g., example 11) relates to a previously described example (e.g., one of the examples 9 to 10) or to any of the examples described herein, further comprising that the machine-readable instructions comprise instructions to obtain previous values transmitted via the connections between the processing elements from buffers having a first-in, first-out mechanism.

Another example (e.g., example 12) relates to a previously described example (e.g., one of the examples 9 to 11) or to any of the examples described herein, further comprising that the machine-readable instructions comprise instructions to obtain previous values transmitted via the connections between the processing elements from buffers being inserted for the purpose of recoverability of the previous values.

Another example (e.g., example 13) relates to a previously described example (e.g., example 12) or to any of the examples described herein, further comprising that at least a subset of the buffers being inserted for the purpose of recoverability comprise a portion of memory being reserved for the purpose of recoverability.

Another example (e.g., example 14) relates to a previously described example (e.g., one of the examples 1 to 13) or to any of the examples described herein, further comprising that the machine-readable instructions comprise instructions to halt the computations being performed by the computational device, and to restart the computations after configuring the computational device with the corrected state.

Another example (e.g., example 15) relates to a previously described example (e.g., one of the examples 1 to 14) or to any of the examples described herein, further comprising that the machine-readable instructions comprise instructions to configure the computational device with the corrected state, and to restart the computations on the computational device after configuring the computational device with the corrected state.

Another example (e.g., example 16) relates to a previously described example (e.g., one of the examples 1 to 15) or to any of the examples described herein, further comprising that the machine-readable instructions comprise instructions to configure a different computational device with the corrected state, and to restart the computations on the different computational device after configuring the different computational device with the corrected state.

Another example (e.g., example 17) relates to a previously described example (e.g., one of the examples 1 to 16) or to any of the examples described herein, further comprising that the machine-readable instructions comprise instructions to selectively correct the state of the computational device in place based on the corrected state.

Another example (e.g., example 18) relates to a previously described example (e.g., one of the examples 1 to 17) or to any of the examples described herein, further comprising that the machine-readable instructions comprise instructions to replace the state of the computational device with the corrected state.

Another example (e.g., example 19) relates to a previously described example (e.g., one of the examples 1 to 18) or to any of the examples described herein, further comprising that the computational device is a spatial computational device.

Another example (e.g., example 20) relates to a previously described example (e.g., example 19) or to any of the examples described herein, further comprising that the spatial computational device is one of a Coarse-Grained Reconfigurable Array (CGRA), a one-time programmable Application Specific Integrated Circuit (ASIC) and a Field-Programmable Gate Array (FPGA).

An example (e.g., example 21) relates to a computer system (100) comprising one or more processors (14) and a computational device (102) being separate from the one or more processors, with the one or more processors implementing the processing circuitry (14) of the apparatus (10) according to one of the examples 1 to 20 (or according to any other example), with the machine-readable instructions being executed by the one or more processors.

An example (e.g., example 22) relates to an apparatus (20) for generating a configuration of a computational device, the apparatus comprising interface circuitry (22), machine-readable instructions and processing circuitry (24) for executing the machine-readable instructions to obtain information on operations to be performed by the computational device. The machine-readable instructions comprise instructions to generate a configuration of the computational device by selecting processing elements and connections between the processing element to be used by the computational device based on the operations to be performed by the computational device, wherein at least one of the processing elements and the connections between the processing element are configured to improve recoverability of a current or previous state of the computational device.

Another example (e.g., example 23) relates to a previously described example (e.g., example 22) or to any of the examples described herein, further comprising that the machine-readable instructions comprise instructions to include or extend buffers in the connections between the processing elements to improve the recoverability of the current or previous state of the computational device.

Another example (e.g., example 24) relates to a previously described example (e.g., example 23) or to any of the examples described herein, further comprising that the inclusion of buffers is performed based on a tradeoff between additional latency caused by the buffers and improvements to recoverability of the current or previous state of the computational device.

Another example (e.g., example 25) relates to a previously described example (e.g., one of the examples 23 to 24) or to any of the examples described herein, further comprising that the inclusion of buffers is performed both to aid in recoverability and to balance capacity with latency in reconvergent paths.

Another example (e.g., example 26) relates to a previously described example (e.g., one of the examples 23 to 25) or to any of the examples described herein, further comprising that at least some buffers have multiple entries, so that a previous state can be received from a non-overwritten buffer entry in the respective buffer.

Another example (e.g., example 27) relates to a previously described example (e.g., one of the examples 23 to 26) or to any of the examples described herein, further comprising that at least some buffers have a first-in, first-out mechanism.

Another example (e.g., example 28) relates to a previously described example (e.g., one of the examples 23 to 27) or to any of the examples described herein, further comprising that the buffers are included as architecturally visible buffers.

Another example (e.g., example 29) relates to a previously described example (e.g., one of the examples 23 to 28) or to any of the examples described herein, further comprising that the buffers are included as architecturally invisible buffers.

Another example (e.g., example 30) relates to a previously described example (e.g., one of the examples 23 to 29) or to any of the examples described herein, further comprising that the machine-readable instructions comprise instructions to perform the selection of a processing element among a group of functionally equivalent processing elements based on the recoverability of the current or previous state of the computational device.

Another example (e.g., example 31) relates to a previously described example (e.g., one of the examples 22 to 30) or to any of the examples described herein, further comprising that the machine-readable instructions comprise instructions to insert a mechanism for halting the computations being performed by the computational device upon detection of a transient error.

An example (e.g., example 32) relates to an apparatus (10) for correcting transient errors in a computational device, the apparatus comprising processing circuitry (14) configured to obtain a signal indicating that a transient error has been detected in the computational device, the computational device being configured to perform computations using processing elements and connections between the processing elements. The processing circuitry is configured to extract a state of the computational device, the state comprising at least one of present and previous values transmitted via the connections between the processing elements and state contained within the one or more processing elements. The processing circuitry is configured to compute a corrected state of the computational device based on the state extracted from the computational device. The processing circuitry is configured to configure a computational device with the corrected state.

An example (e.g., example 33) relates to a computer system (100) comprising one or more processors (14) and a computational device (102) being separate from the one or more processors, with the one or more processors implementing the processing circuitry (14) of the apparatus according to example 32 (or according to any other example).

An example (e.g., example 34) relates to an apparatus (20) for generating a configuration of a computational device (102), the apparatus comprising processing circuitry (24) configured to obtain information on operations to be performed by the computational device. The processing circuitry is configured to generate a configuration of the computational device by selecting processing elements and connections between the processing element to be used by the computational device based on the operations to be performed by the computational device, wherein at least one of the processing elements and the connections between the processing element are configured to improve recoverability of a current or previous state of the computational device.

An example (e.g., example 35) relates to a device (10) for correcting transient errors in a computational device (102), the device comprising means for processing (14) for obtaining a signal indicating that a transient error has been detected in the computational device, the computational device being configured to perform computations using processing elements and connections between the processing elements. The means for processing is configured for extracting a state of the computational device, the state comprising at least one of present and previous values transmitted via the connections between the processing elements and state contained within the one or more processing elements. The means for processing is configured for computing a corrected state of the computational device based on the state extracted from the computational device. The means for processing is configured for configuring a computational device with the corrected state.

An example (e.g., example 36) relates to a computer system (100) comprising one or more processors (14) and a computational device (102) being separate from the one or more processors (14), with the one or more processors implementing the means for processing (14) of the device according to example 35 (or according to any other example).

An example (e.g., example 37) relates to a device (20) for generating a configuration of a computational device, the apparatus comprising means for processing (24) for obtaining information on operations to be performed by the computational device. The device (20) comprises generating a configuration of the computational device by selecting processing elements and connections between the processing element to be used by the computational device based on the operations to be performed by the computational device, wherein at least one of the processing elements and the connections between the processing element are configured to improve recoverability of a current or previous state of the computational device.

An example (e.g., example 38) relates to a method for correcting transient errors in a computational device, the method comprising obtaining (110) a signal indicating that a transient error has been detected in the computational device, the computational device being configured to perform computations using processing elements and connections between the processing elements. The method comprises extracting (120) a state of the computational device, the state comprising at least one of present and previous values transmitted via the connections between the processing elements and state contained within the one or more processing elements. The method comprises computing (140) a corrected state of the computational device based on the state extracted from the computational device. The method comprises configuring (150/155) a computational device with the corrected state.

Another example (e.g., example 39) relates to a previously described example (e.g., example 38) or to any of the examples described herein, further comprising that the method comprises computing (136) valid input values for a processing element having output a value modified by the transient error based on the state of the computational device, and to compute the corrected state based on the valid input values.

Another example (e.g., example 40) relates to a previously described example (e.g., one of the examples 38 to 39) or to any of the examples described herein, further comprising that the method comprises replaying (130) the state preceding the error when computing the corrected state.

Another example (e.g., example 41) relates to a previously described example (e.g., example 40) or to any of the examples described herein, further comprising that the method comprises replaying (130) the state preceding the error in a simulator or debugger to compute the corrected state.

Another example (e.g., example 42) relates to a previously described example (e.g., one of the examples 38 to 41) or to any of the examples described herein, further comprising that the method comprises determining (134), for at least one processing element having a stateful and deterministic behavior, one or more output values based on the state of the computational device, and computing (140) the corrected state based on the one or more output values.

Another example (e.g., example 43) relates to a previously described example (e.g., example 42) or to any of the examples described herein, further comprising that the method comprises determining (134), for at least one processing element having a stateful and deterministic behavior, one or more previous output values based on at least the current state of the processing element and one or more current input values of the processing element.

Another example (e.g., example 44) relates to a previously described example (e.g., one of the examples 38 to 43) or to any of the examples described herein, further comprising that the method comprises determining (134), for at least one processing element, one or more output values, and using (136) the one or more output values as one or more input values to one or more connected processing elements.

Another example (e.g., example 45) relates to a previously described example (e.g., one of the examples 38 to 44) or to any of the examples described herein, further comprising that the method comprises determining (134), for at least one processing element having a stateless and deterministic behavior, one or more output values by determining one or more input values of the at least one processing element based on the state of the computational device.

Another example (e.g., example 46) relates to a previously described example (e.g., one of the examples 38 to 45) or to any of the examples described herein, further comprising that the method comprises obtaining (132) previous values transmitted via the connections between the processing elements from buffers included in the respective connections between the processing elements.

Another example (e.g., example 47) relates to a previously described example (e.g., one of the examples 38 to 46) or to any of the examples described herein, further comprising that the method comprises halting (115) the computations being performed by the computational device, and restarting (160) the computations after configuring the computational device with the corrected state.

Another example (e.g., example 48) relates to a previously described example (e.g., one of the examples 38 to 47) or to any of the examples described herein, further comprising that the method comprises configuring (150) the computational device with the corrected state, and restarting (160) the computations on the computational device after configuring the computational device with the corrected state.

Another example (e.g., example 49) relates to a previously described example (e.g., one of the examples 38 to 48) or to any of the examples described herein, further comprising that the method comprises configuring (155) a different computational device with the corrected state and restarting (165) the computations on the different computational device after configuring the different computational device with the corrected state.

Another example (e.g., example 50) relates to a previously described example (e.g., one of the examples 38 to 49) or to any of the examples described herein, further comprising that the configuring the computational device comprises selectively correcting the state of the computational device in place based on the corrected state.

Another example (e.g., example 51) relates to a previously described example (e.g., one of the examples 38 to 50) or to any of the examples described herein, further comprising that configuring the computational device comprises replacing the state of the computational device with the corrected state.

An example (e.g., example 52) relates to a computer system (100) comprising one or more processors and a computational device being separate from the one or more processors, with the one or more processors being configured to perform the method of one of the examples 38 to 51 (or according to any other example).

An example (e.g., example 53) relates to a method for generating a configuration of a computational device, the method comprising obtaining (210) information on operations to be performed by the computational device. The method comprises generating (220) a configuration of the computational device by selecting processing elements and connections between the processing element to be used by the computational device based on the operations to be performed by the computational device, wherein at least one of the processing elements and the connections between the processing element are configured to improve recoverability of a current or previous state of the computational device.

Another example (e.g., example 54) relates to a previously described example (e.g., example 53) or to any of the examples described herein, further comprising that the method comprises including (224) buffers in the connections between the processing elements to improve the recoverability of the current or previous state of the computational device.

Another example (e.g., example 55) relates to a previously described example (e.g., one of the examples 53 to 54) or to any of the examples described herein, further comprising that the method comprises performing the selection (222) of a processing element among a group of functionally equivalent processing elements based on the recoverability of the current or previous state of the computational device.

Another example (e.g., example 56) relates to a previously described example (e.g., one of the examples 53 to 55) or to any of the examples described herein, further comprising that the method comprises inserting (226) a mechanism for halting the computations being performed by the computational device upon detection of a transient error.

An example (e.g., example 57) relates to a non-transitory machine-readable storage medium including program code, when executed, to cause a machine to perform the method of one of the examples 38 to 51 (or according to any other example) or the method according to one of the examples 53 to 56 (or according to any other example).

An example (e.g., example 58) relates to a computer program having a program code for performing the method of one of the examples the method of one of the examples 38 to 51 (or according to any other example) or the method according to one of the examples 53 to 56 (or according to any other example) when the computer program is executed on a computer, a processor, or a programmable hardware component.

An example (e.g., example 59) relates to a machine-readable storage including machine readable instructions, when executed, to implement a method or realize an apparatus as claimed in any pending claim or shown in any example.

An example (e.g., example A1) relates to a method for constructing a valid state of a computational device from a corrupted state using the current implicit and architecturally visible state by inferring correct values of corrupted state from uncorrupted parts of implicit and architecturally visible state.

In another example (e.g., example A2), the subject-matter of a previous example (e.g., example A1) or of any other example may further comprise, that the computational device has a spatial architecture.

In another example (e.g., example A3), the subject-matter of a previous example (e.g., example A2) or of any other example may further comprise, that the computational device is a Coarse-Grained Reconfigurable Array (CGRA).

In another example (e.g., example A4), the subject-matter of a previous example (e.g., one of the examples A2 or A3) or of any other example may further comprise, that state preceding data corruption is replayed through the computational device to compute a corrected state.

In another example (e.g., example A5), the subject-matter of a previous example (e.g., one of the examples A2 to A4) or of any other example may further comprise, that data channels between processing elements are buffered and buffers retain old values in a First-In First-Out

(FIFO) manner, and old values are retained until overwritten with a newer value.

In another example (e.g., example A6), the subject-matter of a previous example (e.g., example A5) or of any other example may further comprise, that architecturally visible buffers are added to the spatial computation graph to increase recoverability.

In another example (e.g., example A7), the subject-matter of a previous example (e.g., example A6) or of any other example may further comprise, that buffers are used to retain values for recoverability.

In another example (e.g., example A8), the subject-matter of a previous example (e.g., one of the examples A6 or A7) or of any other example may further comprise, that buffers may be configured to enhance recoverability or configured for other purposes.

In another example (e.g., example A9), the subject-matter of a previous example (e.g., one of the examples A6 to A8) or of any other example may further comprise, that buffers may be configured to increase recoverability and satisfy other purposes simultaneously.

In another example (e.g., example A10), the subject-matter of a previous example (e.g., one of the examples A2 to A9) or of any other example may further comprise, that buffers that are not architecturally visible are added to the spatial computation graph to increase recoverability.

In another example (e.g., example A11), the subject-matter of a previous example (e.g., one of the examples A2 to A10) or of any other example may further comprise, that current state of processing elements that change state in a predetermined is used to deduce previous outputs from the current state and the input values consumed and/or number of output values produced.

In another example (e.g., example A12), the subject-matter of a previous example (e.g., one of the examples A2 to A11) or of any other example may further comprise, that some processing elements produce deterministic output values for a given set of inputs.

In another example (e.g., example A13), the subject-matter of a previous example (e.g., one of the examples A2 to A12) or of any other example may further comprise, that where processing graph topology is optimized to enhance recoverability due to implicit and/or explicit state.

In another example (e.g., example A14), the subject-matter of a previous example (e.g., example A13) or of any other example may further comprise, that buffer placement is co-optimized to balance latency and buffering across re-convergent paths and while also enhancing recoverability.

In another example (e.g., example A15), the subject-matter of a previous example (e.g., one of the examples A13 or A14) or of any other example may further comprise, that selection of processing element type is influenced by recoverability.

In another example (e.g., example A16), the subject-matter of a previous example (e.g., one of the examples A2 to A15) or of any other example may further comprise, that the computational device is a Field Programmable Gate Array (FPGA)

In another example (e.g., example A17), the subject-matter of a previous example (e.g., one of the examples A2 to A15) or of any other example may further comprise, that the computational device is a one-time programmable Application Specific Integrated Circuit.

In another example (e.g., example A18), the subject-matter of a previous example (e.g., one of the examples A1 to A17) or of any other example may further comprise, that state is extracted from the computational device when a fault is detected so that a valid state can be computed from the corrupt state on a different system.

In another example (e.g., example A19), the subject-matter of a previous example (e.g., one of the examples A1 to A18) or of any other example may further comprise, that state is corrected in place without extraction.

In another example (e.g., example A20), the subject-matter of a previous example (e.g., one of the examples A1 to A18) or of any other example may further comprise, that state is partially extracted so that corrupted parts of the state can be corrected.

In another example (e.g., example A21), the subject-matter of a previous example (e.g., one of the examples A1 to A20) or of any other example may further comprise, that where computation is restarted from the corrected state after the state is reloaded to the original computational device.

In another example (e.g., example A22), the subject-matter of a previous example (e.g., one of the examples A1 to A21) or of any other example may further comprise, that the corrected state is run in a simulator or debugger.

In another example (e.g., example A22), the subject-matter of a previous example (e.g., one of the examples A1 to A22) or of any other example may further comprise, that the computation is restarted from the corrected state on a different computational device.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for correcting transient errors in a computational device, the apparatus comprising interface circuitry, machine-readable instructions and processing circuitry for executing the machine-readable instructions to:
obtain a signal indicating that a transient error has been detected in the computational device, the computational device being configured to perform computations using processing elements and connections between the processing elements;
extract a state of the computational device, the state comprising at least one of present and previous values transmitted via the connections between the processing elements and state contained within the one or more processing elements;
compute a corrected state of the computational device based on the state extracted from the computational device; and
configure a computational device with the corrected state.

2. The apparatus according to claim 1, wherein the machine-readable instructions comprise instructions to compute valid input values for a processing element having output a value modified by the transient error based on the state of the computational device, and to compute the corrected state based on the valid input values.

3. The apparatus according to claim 1, wherein the machine-readable instructions comprise instructions to replay the state preceding the error when computing the corrected state.

4. The apparatus according to claim 3, wherein the machine-readable instructions comprise instructions to replay the state preceding the error in a simulator or debugger to compute the corrected state.

5. The apparatus according to claim 1, wherein the machine-readable instructions comprise instructions to determine, for at least one processing element having a stateful and deterministic behavior, one or more output values based on the state of the computational device, and to compute the corrected state based on the one or more output values.

6. The apparatus according to claim 5, wherein the machine-readable instructions comprise instructions to determine, for at least one processing element having a stateful and deterministic behavior, one or more previous output values based on at least the current state of the processing element and one or more current input values of the processing element.

7. The apparatus according to claim 1 , wherein the machine-readable instructions comprise instructions to determine, for at least one processing element, one or more output values, and to use the one or more output values as one or more input values to one or more connected processing elements.

8. The apparatus according to claim 1, wherein the machine-readable instructions comprise instructions to determine, for at least one processing element having a stateless and deterministic behavior, one or more output values by determining one or more input values of the at least one processing element based on the state of the computational device.

9. The apparatus according to claim 1, wherein the machine-readable instructions comprise instructions to obtain previous values transmitted via the connections between the processing elements from buffers included in the respective connections between the processing elements.

10. The apparatus according to claim 9, wherein the machine-readable instructions comprise instructions to obtain previous values transmitted via the connections between the processing elements from non-overwritten buffer entries of buffers included in the respective connections between the processing elements.

11. The apparatus according to claim 9, wherein the machine-readable instructions comprise instructions to obtain previous values transmitted via the connections between the processing elements from buffers having a first-in, first-out mechanism.

12. The apparatus according to claim 9, wherein the machine-readable instructions comprise instructions to obtain previous values transmitted via the connections between the processing elements from buffers being inserted for the purpose of recoverability of the previous values, wherein at least a subset of the buffers being inserted for the purpose of recoverability comprise a portion of memory being reserved for the purpose of recoverability.

13. The apparatus according to claim 1, wherein the machine-readable instructions comprise instructions to configure the computational device with the corrected state, and to restart the computations on the computational device after configuring the computational device with the corrected state.

14. The apparatus according to claim 1, wherein the machine-readable instructions comprise instructions to configure a different computational device with the corrected state, and to restart the computations on the different computational device after configuring the different computational device with the corrected state.

15. The apparatus according to claim 1, wherein the machine-readable instructions comprise instructions to selectively correct the state of the computational device in place based on the corrected state.

16. The apparatus according to claim 1, wherein the machine-readable instructions comprise instructions to replace the state of the computational device with the corrected state.

17. The apparatus according to claim 1, wherein the computational device is a spatial computational device, such as one of a Coarse-Grained Reconfigurable Array (CGRA), a one-time programmable Application Specific Integrated Circuit (ASIC) and a Field-Programmable Gate Array (FPGA).

18. An apparatus for generating a configuration of a computational device, the apparatus comprising interface circuitry, machine-readable instructions and processing circuitry for executing the machine-readable instructions to:
obtain information on operations to be performed by the computational device;
generate a configuration of the computational device by selecting processing elements and connections between the processing element to be used by the computational device based on the operations to be performed by the computational device,
wherein at least one of the processing elements and the connections between the processing element are configured to improve recoverability of a current or previous state of the computational device.

19. The apparatus according to claim 18, wherein the machine-readable instructions comprise instructions to include or extend buffers in the connections between the processing elements to improve the recoverability of the current or previous state of the computational device.

20. The apparatus according to claim 19, wherein at least some buffers have multiple entries, so that a previous state can be received from a non-overwritten buffer entry in the respective buffer.

21. The apparatus according to claim 18, wherein the machine-readable instructions comprise instructions to perform the selection of a processing element among a group of functionally equivalent processing elements based on the recoverability of the current or previous state of the computational device.

22. A method for correcting transient errors in a computational device, the method comprising:
obtaining a signal indicating that a transient error has been detected in the computational device, the computational device being configured to perform computations using processing elements and connections between the processing elements;
extracting a state of the computational device, the state comprising at least one of present and previous values transmitted via the connections between the processing elements and state contained within the one or more processing elements;
computing a corrected state of the computational device based on the state extracted from the computational device; and
configuring a computational device with the corrected state.

23. A non-transitory machine-readable storage medium including program code, when executed, to cause a machine to perform the method of claim 22.

24. A method for generating a configuration of a computational device, the method comprising:
obtaining information on operations to be performed by the computational device;
generating a configuration of the computational device by selecting processing elements and connections between the processing element to be used by the computational device based on the operations to be performed by the computational device, wherein at least one of the processing elements and the connections between the processing element are configured to improve recoverability of a current or previous state of the computational device.

25. A non-transitory machine-readable storage medium including program code, when executed, to cause a machine to perform the method of claim 23.
